(19) United States
(12) Patent Application Publication
(10) Pub. No.: US 2008/0263027 A1
(43) Pub. Date: Oct. 23, 2008

(54) PORTABLE DATA STORAGE APPARATUS AND METHOD OF ALLOWING USER TO SELECT DIGITAL DATA USING THE PORTABLE DATA STORAGE APPARATUS

(75) Inventor: Woo-yong CHANG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd, Suwon-si (KR)

(21) Appl. No.: 11/933,561

(22) Filed: Nov. 1, 2007

(30) Foreign Application Priority Data
Apr. 20, 2007 (KR) 10-2007-0038979

(51) Int. Cl. G06F 17/30

(52) U.S. Cl. 707/5; 707/E17.017

(57) ABSTRACT

A data storage apparatus includes a data storage unit which stores digital data; a metadata storage unit which stores metadata regarding a plurality of categories for a plurality of pieces of digital data including the digital data stored in the data storage unit; a search criterion input unit which receives at least one category which is a search criterion, from among the plurality of categories; a list sorting unit which sorts a list of the plurality of pieces of digital data on the basis of item values of the at least one search category; a list display unit which displays the list of digital data; a selection input unit which receives a selected one piece of digital data selected by a user, from among the list of digital data. Accordingly, the user can easily and quickly search for his or her desired data.

### CROSS-REFERENCE TO RELATED PATENT APPLICATION

This application claims priority from Korean Patent Application No. 10-2007-0038979, filed on Apr. 20, 2007, in the Korean Intellectual Property Office, the disclosure of which is incorporated herein by reference in its entirety.

### BACKGROUND OF THE INVENTION

1. Field of the Invention

Methods and apparatuses consistent with the present invention relate to processing of digital data, and more particularly, to a method of allowing a user to search for a plurality of pieces of digital data in order to select one piece of digital data from among the plurality of pieces of digital data in a portable data storage apparatus.

2. Description of the Related Art

An exemplary apparatus for storing a plurality of pieces of digital data and allowing users to select one piece of digital data from among the plurality of pieces of digital data is a digital music reproducing apparatus. A representative digital music reproducing apparatus is an MP3 player.

However, the digital music reproducing apparatus for storing and reproducing digital source data is provided as an example, and the present invention is not limited to this and can be applied to different apparatuses for storing digital data.

A digital music reproducing apparatus stores a plurality of sound source data files, allows a user to select a sound source data file from among the plurality of sound source data files, and reproduces the sound source data file selected by the user.

As memory performance has recently improved, a digital music reproducing apparatus can store a large amount of sound source data files. Also, when digital data is not stored in a data storage device installed in the digital music reproducing apparatus, the digital music reproducing apparatus can make out a list of the digital data, allow a user to select one piece of data from among the list of digital data, receive the data selected by the user from a different data storage apparatus, and reproduce the data. Accordingly, a method of quickly and easily searching for a plurality of pieces of digital data is needed.

### SUMMARY OF THE INVENTION

The present invention provides a data storage apparatus for allowing a user to quickly and easily search for a plurality of pieces of digital data, and a method of allowing a user to select digital data using the data storage apparatus.

The present invention also provides a computer-readable recording medium having encoded thereon a program for executing a method of allowing a user to select digital data.

The present invention provides a method and apparatus for receiving at least one search category with respect to metadata stored in a data storing unit, and sorting a list of digital data on the basis of an item value of the received search category, thereby allowing a user to easily and quickly search for his or her desired digital data from among a plurality of pieces of digital data.

According to an aspect of the present invention, there is provided a method of allowing a user to select one piece of digital data from among a plurality of pieces of digital data, in a data storage apparatus storing metadata regarding a plurality of categories for the plurality of pieces of digital data, the method including: receiving a first search category which is a search criterion, from among the plurality of categories; sorting a list of the plurality of pieces of digital data on the basis of item values of the first search category; displaying the sorted list of the plurality of pieces of digital data; and receiving a selection of one piece of digital data by the user among the list of the plurality of pieces of digital data.

The sorting of the list of the plurality of pieces of digital data further includes sorting digital data having the same item value of the first search category, on the basis of item values of a second search category, wherein the second search category is a category different from the first search category, from among the plurality of categories.

The receiving of the first search category includes successively receiving the first search category and the second search category.

The displaying of the sorted list of the digital data includes: receiving an upward movement signal or a downward movement signal; and moving the list of digital data upwardly or downwardly, according to the upward movement signal or the downward movement signal, and displaying the resultant list of digital data.

The upward or downward moving of the list of digital data and the displaying of the resultant list of digital data includes: if the upward movement signal or the downward movement signal is a normal movement signal, moving the list of digital data upwardly or downwardly in units of digital data pieces, and displaying the resultant list of digital data; and if the upward movement signal or the downward movement signal is a fast movement signal, moving the list of digital data upwardly or downwardly in units of pages, and displaying the resultant list of digital data.

The digital data is sound source data, and the plurality of

The method further includes displaying an item value for each of the plurality of categories, for the selected digital data.

The method further includes reproducing the selected digital data. The method further includes, if the selected digital data is not stored in the data storage apparatus, requesting a different data storage apparatus to transmit the selected digital data, and receiving the selected digital data from the other data storage apparatus.

According to another aspect of the present invention, there is provided a data storage apparatus including: a data storage unit storing digital data; a metadata storage unit storing metadata regarding a plurality of categories for a plurality of pieces of digital data including the digital data stored in the data storage unit; a search criterion input unit receiving at least one search category which is a search criterion, from among the plurality of categories; a list sorting unit sorting a list of the plurality of pieces of digital data on the basis of item values of the at least one search category; a list display unit displaying the list of digital data; a selection input unit receiving a selection of one piece of digital data by a user, from among the list of digital data.

The search criterion input unit includes a plurality of input buttons corresponding to the plurality of categories, and if at least one input button of the plurality of input buttons is pressed, a search category corresponding to the at least one input button is input to the list sorting unit.

If an input button of the plurality of input buttons is pressed, a category corresponding to the input button is input as a first search category to the list sorting unit, and the list storing unit sorts a list of the plurality of pieces of digital data on the basis of item values of the first search category.

If two input buttons of the plurality of input buttons are successively pressed, categories corresponding to the two input buttons are input as a first search category and a second search category to the list sorting unit, and the list sorting unit sorts the list of the plurality of pieces of digital data on the basis of item values of the first search category, and then sorts a list of digital data having the same item value of the first search category, on the basis of item values of a second search category.

The selection input unit further includes a movement signal input unit receiving an upward movement signal or a downward movement signal, and transferring the upward movement signal or the downward movement signal to the list display unit, wherein, if the upward movement signal or the downward movement signal is transferred from the movement signal input unit, the list display unit moves the list of digital data upwardly or downwardly according to the upward movement signal or the downward movement signal, and displays the resultant list of digital data.

If the upward movement signal or the downward movement signal is a normal movement signal, the list display unit moves the list of digital data upwardly or downwardly in a unit of a digital data piece and displays the resultant list of digital data, and if the upward movement signal or the downward movement signal is a fast movement signal, the list display unit moves the list of digital data upwardly or downwardly in a unit of a page and displays the resultant list of digital data.

The movement signal input unit includes two input buttons corresponding to the upward movement signal and the downward movement signal, recognizes as a normal movement signal a movement signal having a direction corresponding to a pressed input button of the two input buttons if the pressed input button is pressed for a short time, and transfers the normal movement signal to the list display unit, and recognizes as a fast movement signal a movement signal having a direction corresponding to a pressed input button of the two input button if the pressed input button is pressed for a long time, and transfers the fast movement signal to the list display unit.

The digital data is sound source data, and the plurality of categories include an artist, an album, a genre, and a title.

The apparatus further includes a selected data display unit displaying an item value for each of the plurality of categories, for the selected digital data.

The apparatus further includes a data reproducing unit reproducing the selected digital data.

The apparatus further includes a data interface unit requesting another data storage apparatus to transmit the selected digital data, if the selected digital data is not stored in the data storage unit, receiving the selected digital data from the other data storage apparatus, and storing the selected digital data in the data storage unit.

### BRIEF DESCRIPTION OF THE DRAWINGS

The above and other features of the present invention will become more apparent by describing in detail exemplary embodiments thereof with reference to the attached drawings in which:

FIG. 1 is a block diagram illustrating a digital data storage apparatus according to an exemplary embodiment of the present invention;

FIG. 2 is a flowchart illustrating a method of allowing a user to select digital data, according to an exemplary embodiment of the present invention;

FIG. 3 is a flowchart illustrating a method of allowing a user to select digital data, according to another exemplary embodiment of the present invention;

FIG. 4 illustrates a physical user interface (PUI) of a portable data storage apparatus according to an exemplary embodiment of the present invention;

FIGS. 5 through 8 illustrate PUIs of a portable data storage apparatus, according to other exemplary embodiments of the present invention;

FIGS. 9 and 10 are views illustrating operations of successively inputting two search categories;

FIG. 11 shows an example of metadata of digital data consisting of item values for a plurality of categories;

FIG. 12 shows an example of a sorted data list for which one search category is used;

FIG. 13 shows a sorted data list for which “ARTIST” and “TITLE” are respectively input as a first search category and a second search category;

FIG. 14 shows a data list for which “GENRE” and “TITLE” are respectively input as a first search category and a second search category;

FIGS. 15 and 16 are views illustrating a method of displaying a list of digital data on a list display unit according to an upward or downward movement signal which is input through a movement signal input unit; and

FIG. 17 is a view illustrating a data search method according to a conventional technique.

### DETAILED DESCRIPTION OF THE INVENTION

Hereinafter, exemplary embodiments of a data storage apparatus and a method of inputting a selection of data using the data storage apparatus according to the present invention will be described in detail with reference to the appended drawings.

The present invention provides a method and apparatus for receiving at least one search category with respect to metadata stored in a data storing unit, and sorting a list of digital data on the basis of an item value of the received search category, thereby allowing a user to easily and quickly search for his or her desired digital data from among a plurality of pieces of digital data.

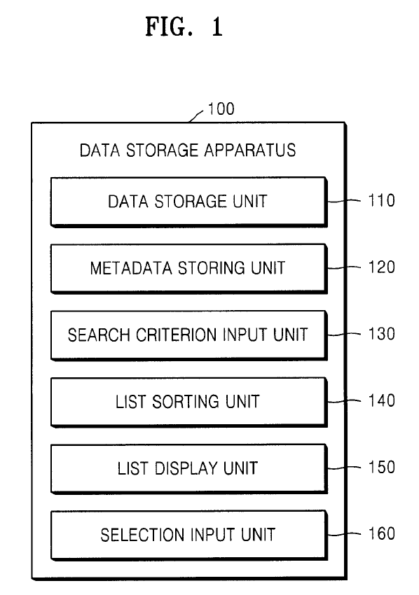

FIG. 1 is a block diagram illustrating a data storage apparatus 100 according to an exemplary embodiment of the present invention. Referring to FIG. 1, the data storage apparatus 100 includes a data storing unit 110, a metadata storing unit 120, a search criterion input unit 130, a list sorting unit 140, a list display unit 150, and a selection input unit 160.

The data storing unit 110 stores digital data. The digital data may be sound source data, however, the present invention is not limited to this and can be applied to general digital data.

The metadata storing unit 120 stores metadata regarding a plurality of categories for digital data. The metadata storing unit 120 can store metadata for digital data stored in other data storage apparatuses, as well as the metadata for the digital data stored in the data storing unit 110.

In the case of sound source data, four categories of an artist, an album, a genre, and a title can be used. However, the present invention is not limited to these and may use only 2 or 3 categories, or use 5 or more categories.

The metadata for the digital data includes item values corresponding to the categories. For example, metadata for digital data 522 can have a value indicating that an artist is “BOA”, a genre is “DANCE POP”, an album is “MADE IN TWENTY”, and a title is “WINTER LOVE”.

The search category input unit 130 receives at least one search category from a user. The search category means a category which is used as a criterion for searching for data.

The list sorting unit 140 sorts a list of a plurality of pieces of digital data according to an item value of an input search category. As described above, such a list of digital data can further include a list of digital data stored in other data storing devices, as well as the digital data stored in the data storing unit 110.

The list display unit 150 displays the sorted list of digital data.

The selection input unit 160 receives a selection of one piece of digital data from a user among the list of digital data.

The selection input unit 160 can further include a movement signal input unit for receiving an upward or downward movement signal and transferring the upward or downward signal to the list display unit 150. If the movement signal input unit transfers an upward or downward movement signal to the list display unit 150, the list display unit 150 moves the list of digital data in an up or down direction according to the upward or downward movement signal, and then displays the list of digital data. For example, if an upward movement signal is transferred to the list display unit 150, the list display unit 150 moves the list of digital data in the down direction and displays the list of digital data, and if a downward movement signal is transferred to the list display unit 150, the list display unit 150 moves the list of digital data in the up direction and displays the list of digital data.

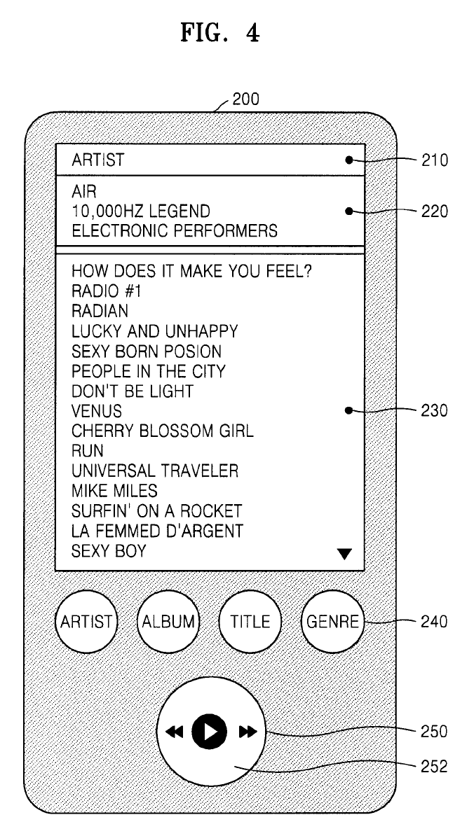

According to another exemplary embodiment of the present invention, the data storage apparatus 100 can further include a selected data display unit (not shown). The selected data display unit displays an item value regarding each category with respect to selected digital data. The operation will be described in more detail later with reference to FIG. 4.

According to still another exemplary embodiment of the present invention, the data storage apparatus 100 can further include a data reproducing unit (not shown). The data reproducing unit reproduces the selected digital data. The selected digital data may be digital data stored in another data storing device. In this case, the data storage apparatus 100 preferably further includes a data interface unit (not shown).

If the selected digital data is not stored in the data storing unit 110, the data interface unit sends a request for transmission of the selected digital data to the other data storing device which stores the selected digital data, receives the selected digital data from the other data storing device, and stores the selected digital data in the data storing unit 110.

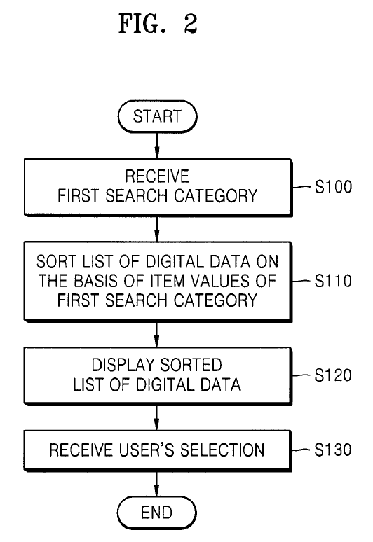

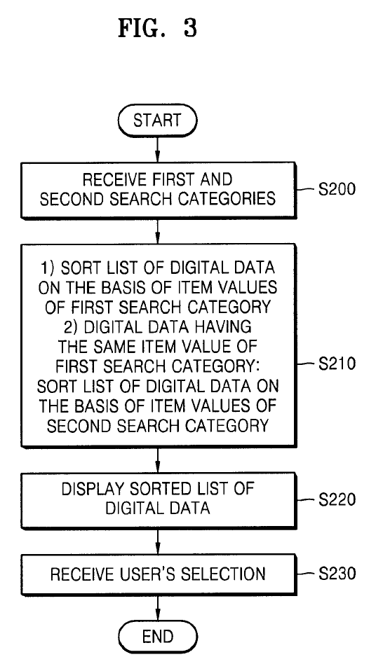

FIGS. 2 and 3 are flowcharts illustrating methods of allowing a user to select digital data, according to exemplary embodiments of the present invention.

FIG. 2 illustrates an exemplary embodiment of when one search category is input, and FIG. 3 illustrates an exemplary embodiment of when two search categories are input.

Referring to FIGS. 1 and 2, the search category input unit 130 receives a first search category which is a search criterion (operation S100). The first search category may be a category selected by a user from a plurality of categories. In the case of sound source data, the plurality of categories may be an artist, an album, a genre, and a title. For example, if an album is received as the first search category, an album name becomes a search criterion.

The list sorting unit 140 sorts a list of digital data according to item values of the first search category (operation S110). The item values of the first search category means specific item values of digital data for the first search category. For example, if “ALBUM” is received as the first search category, item values of the first search category may be “10,000 HZ LEGEND”, “TALKIE WALKIE”, “MADE IN TWENTY”, etc. The meaning of “sorting the list of digital data according to the item values of the first search category” is to sort the list of digital data in the order of the item values of the first search category.

After the list of digital data is sorted, the list display unit 150 displays the sorted list of digital data (operation S120).

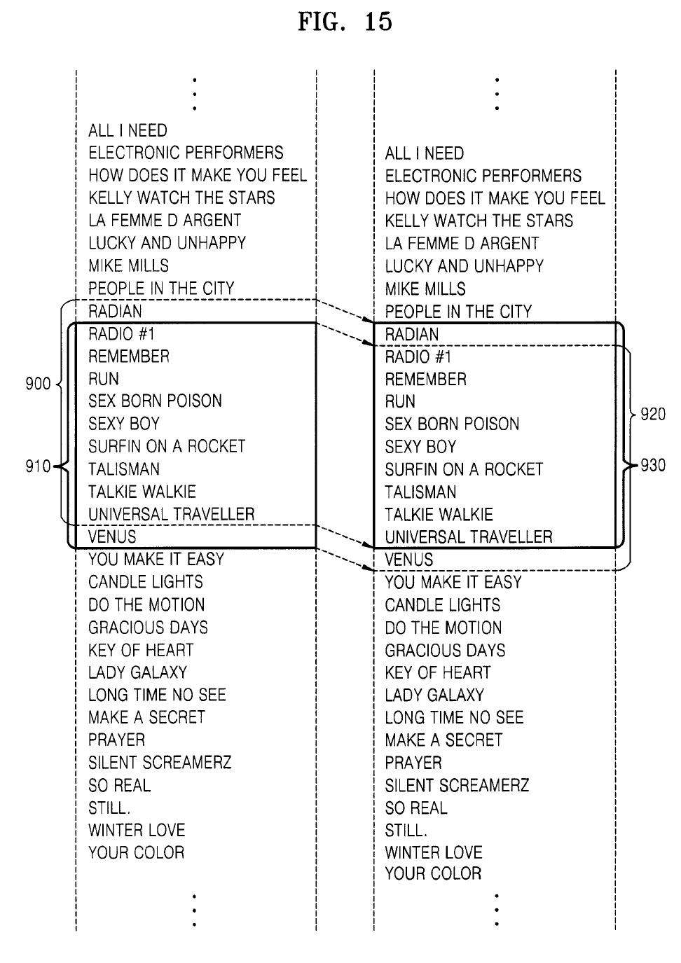

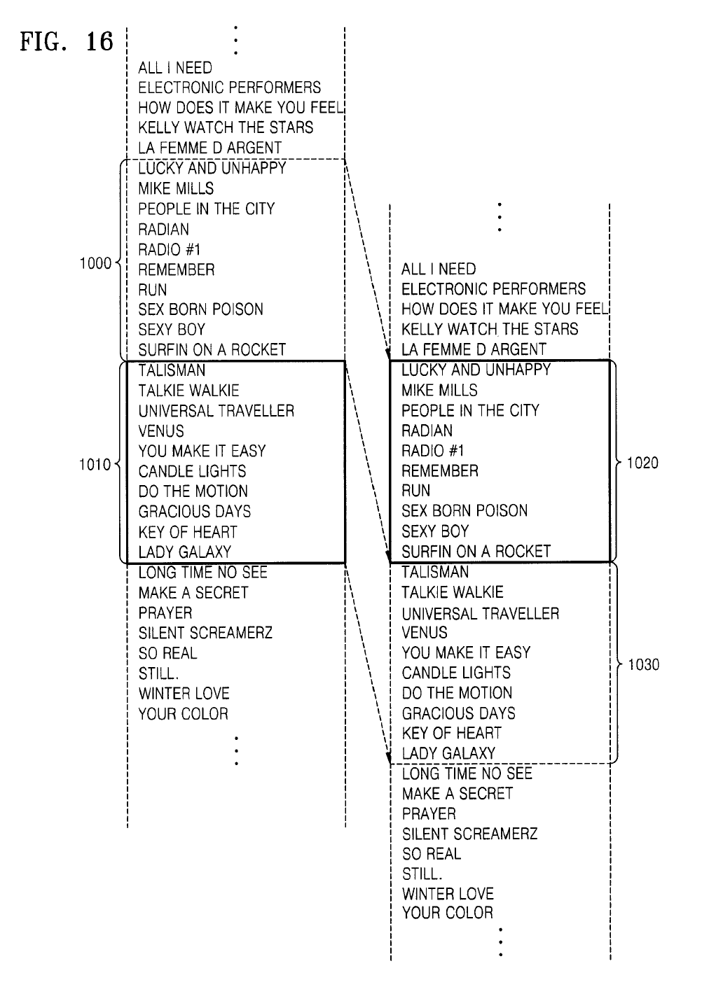

Since the portable data storage apparatus 100 has a limitation in terms of size, the list display unit 150 can display only a part of the list of digital data. Accordingly, the list display unit 150 can display a part of the list of digital data according to a user's input. A method in which the list display unit 150 displays the list of digital data will be described in more detail later with reference to FIGS. 15 and 16.

The selection input unit 160 receives a selection of one piece of digital data from a user among the list of digital data (operation S130).

FIG. 3 illustrates an exemplary embodiment of when two search categories are received.

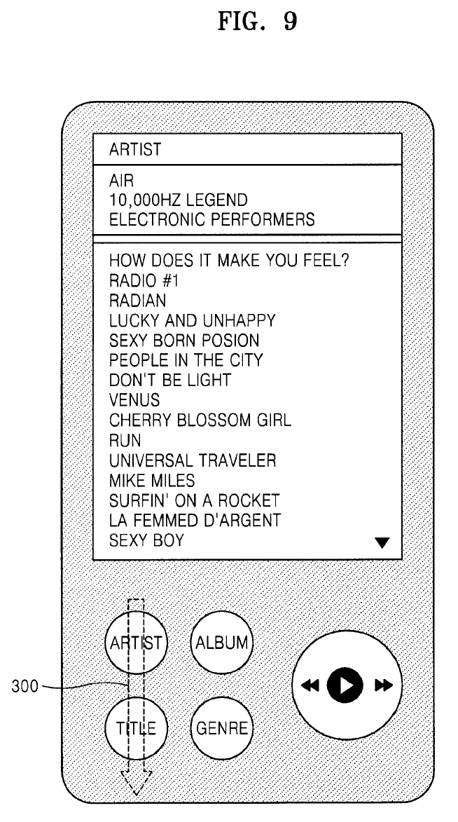

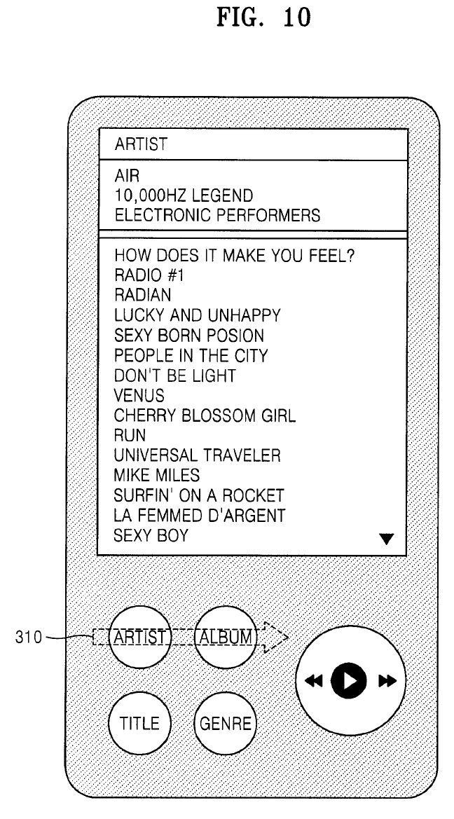

Referring to FIGS. 1 and 3, the search category input unit 130 receives a first search category and a second search category (operation S200). A method for simultaneously receiving the first and second search categories will be described in detail later with reference to FIGS. 9 and 10.

The list sorting unit 140 sorts a list of digital data on the basis of item values of the first and second search categories (operation S210).

First, the list of digital data is sorted on the basis of the item values of the first search category. At this time, digital data having the same item value of the first search category is sorted on the basis of the item values of the second search category.

In the exemplary embodiment of FIG. 2, digital data having the same item value of the first search category may be listed without any specific order. However, in the embodiment of FIG. 3, digital data is first sorted according to the item values of the first search category, and digital data having the same item value of the first search category is secondarily sorted according to the item values of the second search category.

After the list of digital data is sorted, the list display unit 150 displays the sorted list of digital data (operation S220), and the selection input unit 160 receives a selection of one piece of digital data from a user among the list of digital data (operation S230).

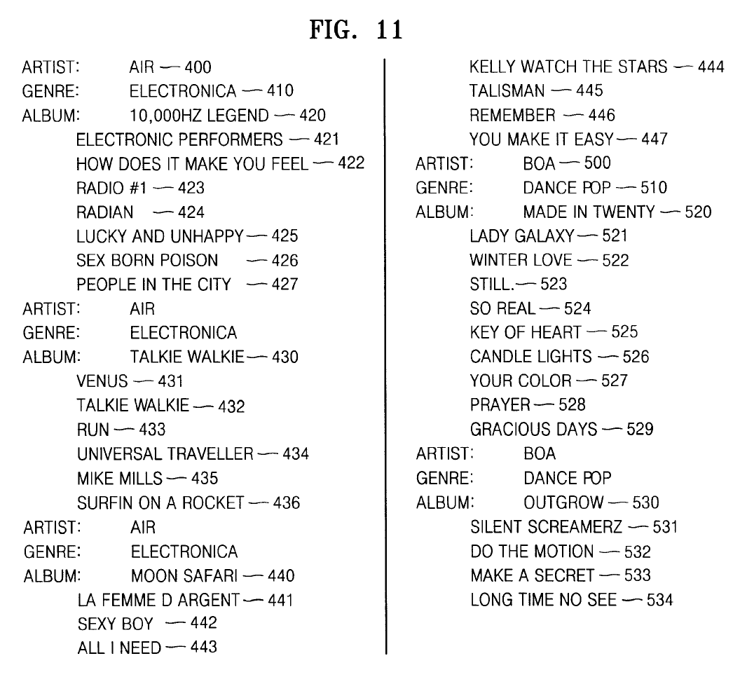

Examples in which digital data is sorted according to the methods illustrated in FIGS. 2 and 3 will be described in more detail later with reference to FIGS. 11 through 14.

FIG. 4 illustrates a physical user interface (PUI) of a portable data storage apparatus 200 according to an exemplary embodiment of the present invention.

Referring to FIG. 4, the portable data storage apparatus 200 includes a search category display window 210, a selected data display window 220, a list display window 230, a plurality of search category input buttons 240, and a list movement and data selection input unit 250.

The search category display window 210 displays a search category which is input by a user. FIG. 4 shows an exemplary embodiment in which only a first search category is displayed. However, if a plurality of search categories are input by a user, all the input search categories can be displayed.

The selected data display window 220 displays item values of each category regarding digital data which is selected by the user from a displayed list of digital data. The selected data display window 220 illustrated in FIG. 4 is an exemplary embodiment of the selected data display unit described above with reference to FIG. 1.

FIG. 4 shows a case where a title “ELECTRONIC PERFORMERS” included in an album “10,000 HZ LEGEND” of an artist “AIR” is selected.

The list display window 230 displays a list of sorted data. The list display window 230 is an exemplary embodiment of the list display unit 150 described above with reference to FIG. 1.

The search category input buttons 240 are an exemplary embodiment of the search reference input unit 130 described above with reference to FIG. 1. In FIG. 4, four input buttons respectively corresponding to four categories “ARTIST”, “ALBUM”, “TITLE”, and “GENRE” are illustrated. By pressing the input buttons, search categories corresponding to the pressed input buttons are input.

If a user presses an input button among the search category input buttons 240, a category corresponding to the input button is input as a first search category. The list sorting unit 140 sorts a list of digital data on the basis of item values of the first search category, and displays a part of the sorted list of digital data on the list display window 230.

If the user successively presses two input buttons among the search category input buttons 240, two categories corresponding to the two input buttons are input as a first search category and a second search category. Successively pressing two buttons means pressing two buttons with a very short time interval therebetween. For example, it can be set that pressing two buttons at a time interval within 0.5 second of each other is “successively pressing two buttons”. However, the length of a time interval that is considered as “successively pressing two buttons” depends on settings of the portable data storage apparatus 200.

The list movement and data selection input unit 250 corresponds to the selection input unit 160 described in FIG. 1. Referring to FIG. 4, a data selection input button is located in the center part of the list movement and data selection input unit 250. If the data selection input button is pressed, digital data located at the top of a data list displayed on a current list display window 230 is selected.

The upper and lower parts of the list movement and data selection input unit 250 are buttons for moving the list displayed on the list display window 230 in an up or down direction, and correspond to the movement signal input unit described above with reference to FIG. 1. If one of the buttons is pressed for a short time, a “normal movement signal” is generated, and if one of the buttons is pressed for a long time, a “fast movement signal” is generated.

For example, if a part denoted by a reference number 252 is pressed for a short time, the list displayed on the list display window 230 is moved in an up direction in a unit of a data piece, and digital data following final digital data of the list displayed on the list display window 230 is displayed on the bottom line of the list display window 230. By performing this operation, the same effect as if the list display window 230 is moved downwardly is obtained.

Also, if the part denoted by the reference number 252 is pressed for a long time, digital data of one page following final data of the list displayed on the list display window 230 is displayed on the list display window 230.

The movement of the list according to the inputting of the normal movement signal and the fast movement signal will be described in more detail later with reference to FIGS. 15 and 16.

The normal movement signal and the fast movement signal can be set according to settings of the portable data storage apparatus 200. For example, a case of pressing a button for a time period which is within 0.1 seconds can be set to “pressing a button for a short time”, and a case of pressing a button for a time period which exceeds 0.1 seconds can be set to “pressing a button for a long time”. However, the settings depend on the internal settings of the portable data storage apparatus 200, and the present invention is not limited to the above example.

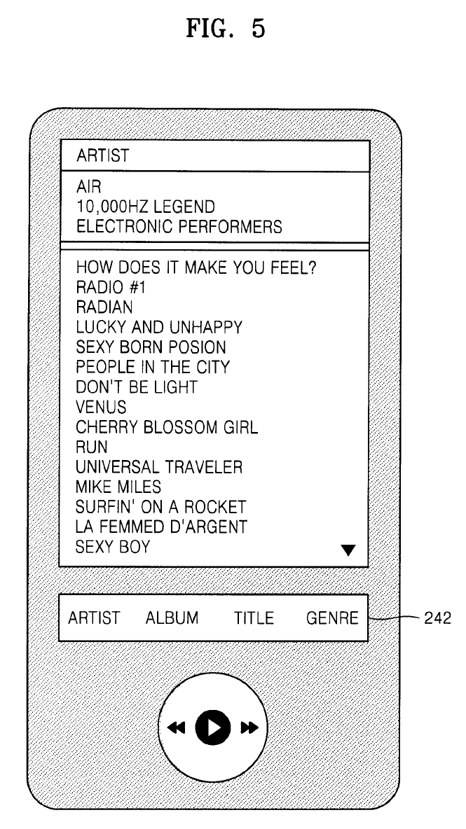

FIGS. 5 through 8 illustrate PUIs of the portable data storage apparatus, according to other exemplary embodiments of the present invention.

FIG. 5 shows a case where a slide bar 242 is adopted instead of the search category input buttons 240, in the portable data storage apparatus 200 illustrated in FIG. 4. In the slide bar 242, a search category corresponding to a part which a finger contacts is input.

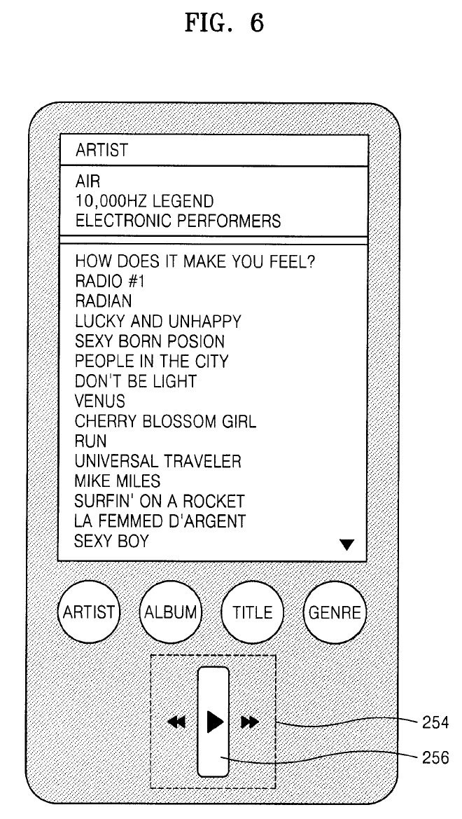

FIG. 6 shows a case where a modification 254 of the list movement and data selection input unit 250 is adopted in the portable data storage apparatus 200 illustrated in FIG. 4. In FIG. 6, a slide bar 256 is adopted instead of the data selection input buttons and the upward and downward movement buttons illustrated in FIG. 4.

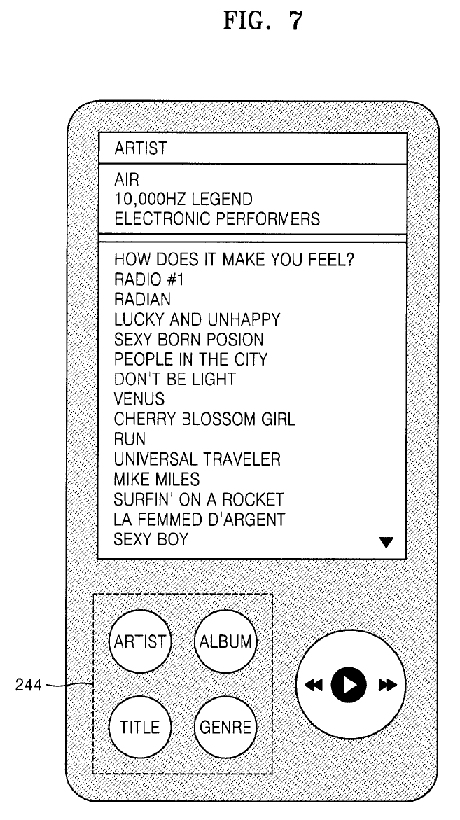

FIG. 7 shows a case where the locations of the search category input buttons 240 illustrated in FIG. 4 are changed in the portable data storage apparatus 200 illustrated in FIG. 4. Four search category input buttons 244 illustrated in FIG. 7 are arranged in such a manner that the intervals between the four buttons 244 are at a minimum with respect to one another. By this structure, successively inputting two search categories is easier than in the embodiment illustrated in FIG. 4. For example, in order to successively input two search categories through the portable data storage apparatus illustrated in FIG. 4, two fingers may have to be used. However, in the portable data storage apparatus illustrated in FIG. 7, successively inputting two search categories using a single finger is possible. This operation will be described in more detail later with reference to FIGS. 9 and 10.

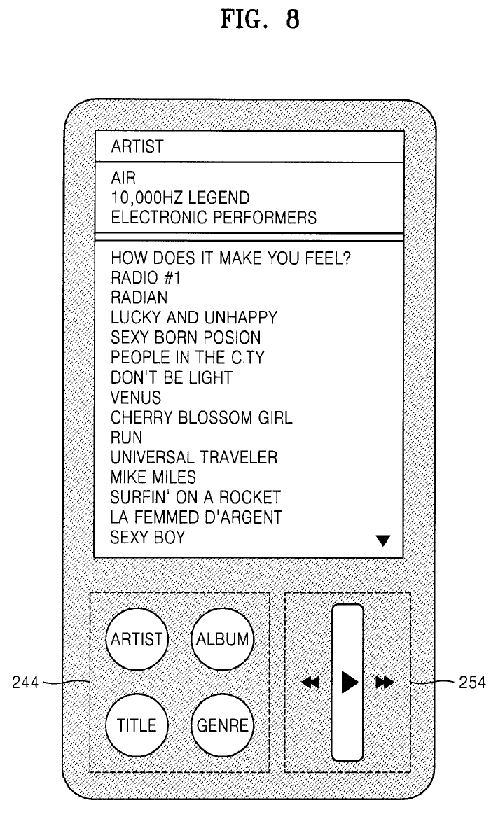

FIG. 8 shows a case where the search category input buttons 244 between which intervals are at a minimum as illustrated in FIG. 7 and a slide bar-shaped input unit 254 are adopted.

However, the present invention is not limited to the examples illustrated in the above drawings, and the physical interface can be modified in the form of a variety of structures.

FIGS. 9 and 10 are views illustrating operations of successively inputting two search categories. Referring to FIGS. 9 and 10, it will be described how the search category input buttons 244 illustrated in FIG. 7 have an effective arrangement to successively input a plurality of search categories.

FIG. 9 shows a case where two categories “ARTIST” and “TITLE” are successively input. If a user successively presses buttons in a direction indicated by an arrow 300 of FIG. 9, two categories “ARTIST” and “TITLE” are successively input. In this case, the category “ARTIST” becomes a first search category, and the category “TITLE” becomes a second search category.

FIG. 10 shows a case where two categories “ARTIST” and “ALBUM” are successively input. If a user successively presses buttons in a direction indicated by an arrow 310, two categories “ARTIST” and “ALBUM” are successively input. In this case, the category “ARTIST” becomes a first search category, and the category “ALBUM” becomes a second search category.

As described above, in the portable data storage apparatus and the method of allowing a user to select digital data using the portable data storage apparatus, according to the present invention, by sorting a list of digital data on the basis of item values of an input search category, a user can search for his or her desired digital data.

Hereinafter, it will be described in detail how the method according to the present invention is faster and easier in terms of data searching than conventional methods, with reference to FIGS. 11 through 17.

FIG. 11 shows an example of metadata regarding digital data consisting of item values for a plurality of categories. Referring to FIG. 11, the metadata is hierarchically stored in a data storage apparatus. In the example of FIG. 11, a hierarchical order of “ARTIST”, “GENRE”, “ALBUM”, and “TITLE” is designated.

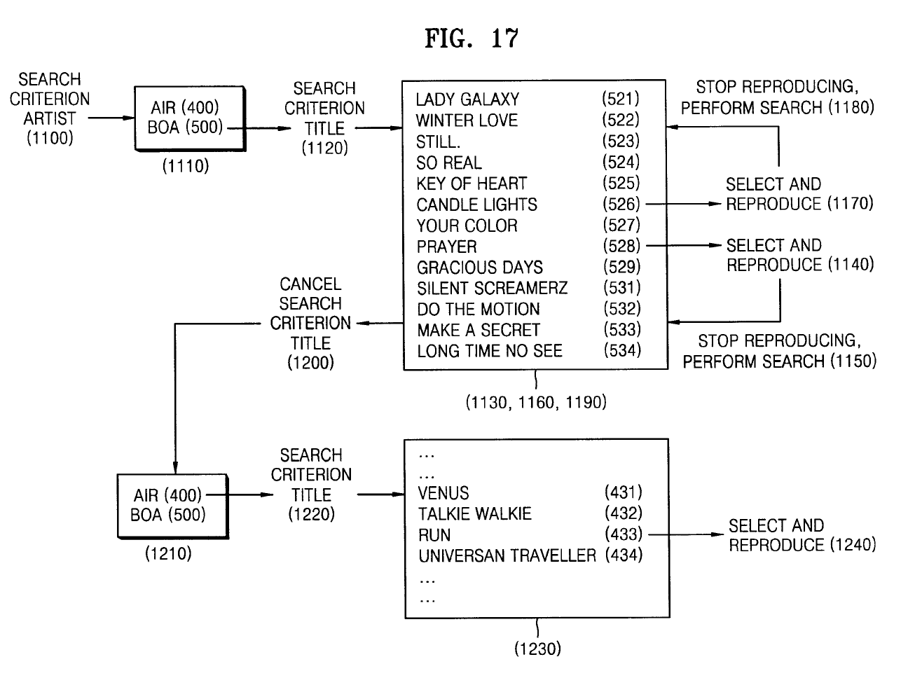

In a conventional digital data storage apparatus, digital data is searched for according to a hierarchical structure as illustrated in FIG. 11. For example, in order to search for digital data having a title “PRAYER” 528 of an artist “BOA” 500, the following procedure has to be followed. The procedure will now be described with reference to FIG. 17.

Referring to FIG. 17, if a search category “ARTIST” is input (operation 1100), item values corresponding to the “ARTIST” are displayed from the corresponding metadata (operation 1110). In the example of FIG. 11, two item values “AIR” 400 and “BOA” 500 are displayed. If a user selects “BOA” 500 from among the displayed item values, data having an item value “BOA” of the category “ARTIST” is selected from among all data.

Then, if a search category “TITLE” is input (operation 1120), item values corresponding to the “TITLE” are displayed from metadata of the data having the item value “BOA” of the category “ARTIST” (operation 1130). In the example of FIG. 11, “TITLE” item values of the data having the item value “BOA” of the category “ARTIST” are titles from “LADY GALAXY” 521 to “LONG TIME NO SEE” 534.

If the user selects “PRAYER” 528 from the displayed data, the “PRAYER” 528 is reproduced (operation 1140). There is a case where the user wants to listen to another title music (for example, “CANDLE LIGHTS” 526) of the “BOA” 500 while the “PRAYER” 528 is reproduced. In this case, the user has to stop reproduction of the “PRAYER” 528, and input data to again perform a hierarchical search (operation 1150). In this case, data (521-529 and 531-534) having an item value “BOA” of the category “ARTIST” will be displayed (operation 1160). The user can select “CANDLE LIGHTS” 526 from among the displayed data, and reproduce it (operation 1170).

However, there is also a case where the user wants to listen to title music “RUN” 433 of the artist “AIR” 400 while he or she selects and reproduces “CANDLE LIGHTS” 526 of “BOA” 500. In this case, the user first stops reproduction of “CANDLE LIGHTS” 526 and inputs data to again perform a hierarchical search (operation 1180). In this case, data (521-529 and 531-534) having the item value “BOA” of the category “ARTIST” will be displayed (operation 1190). By pressing a movement button to the upper layer, the user cancels the selection of the search category “TITLE” (operation 1200). Accordingly, by the search criterion “ARTIST” which was selected before, the item values “AIR” 400 and “BOA” 500 corresponding to the “ARTIST” are displayed from among the corresponding metadata (operation 1210). The user selects the item value “AIR” 400 from among the displayed item values “AIR” 400 and “BOA” 500, and inputs “TITLE” as a search category (operation 1220). Then, “TITLE” item values of data having an item value “AIR” 400 of the category “ARTIST” are displayed (operation 1230). The user selects data “RUN” 433 from among the displayed data, and reproduces the data “RUN” 433 (operation 1240).

As such, the conventional digital data search method hierarchically searches for a list of data, and thus requires a user to select data at an exact location. However, selecting an exact location on a layer of metadata regarding a plurality of pieces of digital data does not match a user's cognitive thought structure and places a manipulation load on the user. For example, in the procedure illustrated in FIG. 17, in order to change a selection of data from “CANDLE LIGHTS” 526 of “BOA” 500 to “RUN” of “AIR” 400, the user has to perform button manipulations five or more times.

Also, under the hierarchical structure, the user has to continuously check a current location. That is, the user has to know an order of a currently selected search criterion, as well as a category to which the currently selected search criterion belongs. For example, if “ARTIST” is selected as a first search criterion and “TITLE” is selected as a second search criterion and then the second search criterion “TITLE” is cancelled, the process returns to an environment in which the “ARTIST” is used as a search criterion. However, if the user wants to use “GENRE” as the most significant search criterion, he or she has to cancel the “TITLE” which is the first search criterion and select the “GENRE” as a first search criterion

Meanwhile, a data search method according to the present invention sorts a list of all data linearly, and directly accesses desired data from the list so as to select the desired data. The data search method according to the present invention matches a user's cognitive thought structure, and places a relatively low manipulation load on users. Also, according to the data search method, users can easily access desired data compared to the conventional method.

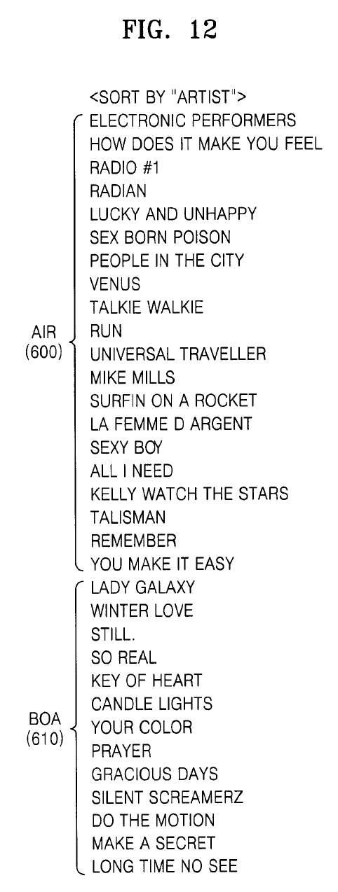

FIG. 12 shows an example of a sorted data list for which one search category is used, wherein item values of digital data are item values of the category “TITLE” illustrated in FIG. 11.

In FIG. 12, “ARTIST” is input as a first search category. In the example of FIG. 11, “AIR” 400 and “BOA” 500 are provided as item values of the first category “ARTIST”. Accordingly, all data is classified and displayed as data 600 having the item value “AIR” of the category “ARTIST”, and data 610 in which item values of the category “ARTIST” are “BOA”.

In the example of FIG. 12, no specific order is designated to data having the same item value. Accordingly, in the case of the data 600 having the item value “AIR” in the category “ARTIST”, it is difficult to search for data having a desired title.

In order to solve this problem, a method of successively inputting a first search category and a second search category is provided.

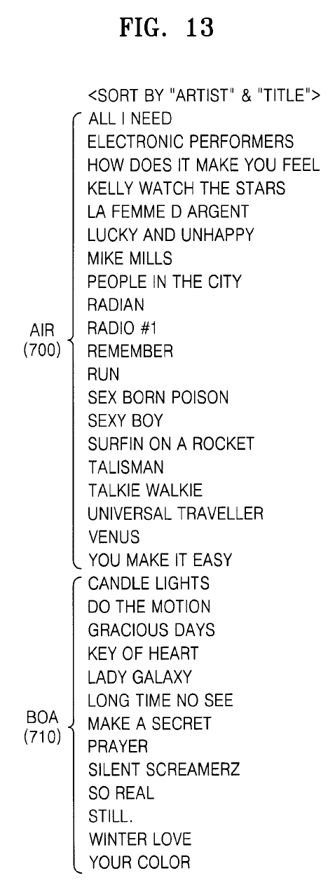

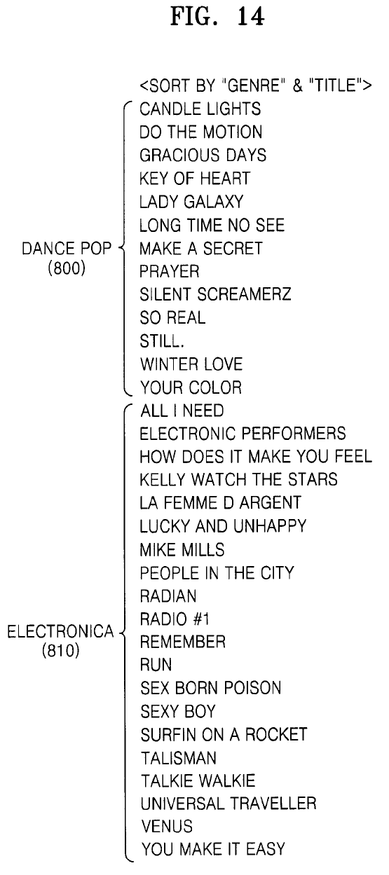

FIGS. 13 and 14 are views illustrating a method in which two search categories are input together.

FIG. 13 shows a sorted data list for when “ARTIST” and “TITLE” are respectively input as a first search category and a second search category. Referring to FIG. 13, data having the same item value of the first category “ARTIST” is sorted on the basis of item values of the second category “TITLE”. For example, data 700 having an item value “AIR” of the first category “ARTIST” is arranged in alphabetical order from “ALL I NEED” to “YOU MAKE IT EASY”. Also, data 710 having an item value “BOA” of the first category “ARTIST” is arranged in alphabetical order from “CANDLE LIGHTS” to “YOUR COLOR”.

FIG. 14 shows a sorted data list for when “GENRE” and “TITLE” are respectively input as a first search category and a second search category. In the example of FIG. 11, the genre of music whose artist is “AIR” is “ELECTRONICA”, and the genre of music whose artist is “BOA” is “DANCE POP”. Accordingly, in FIG. 14, data is first sorted on the basis of item values of “GENRE” which is the first search category, and data having the same item value of the first search category “GENRE” is sorted on the basis of item values of “TITLE” which is the second search category, so that a data list is displayed. Since a portable data storage apparatus has a limitation in terms of size, the portable data storage apparatus cannot display a data list all at once. Accordingly, when a user wants to view other data included in the data list, he or she has to move a list displayed on a list display unit (that is, a data display window) upwardly or downwardly so that his or her desired data part is displayed on the data display window.

FIGS. 15 and 16 are views illustrating a method of displaying a list of digital data on a list display unit 150 (see FIG. 1) according to an upward or downward movement signal which is input through a movement signal input unit.

FIG. 15 shows a case in which a normal movement signal is input. The normal movement signal is generated when a button or a slide bar for generating an upward or downward movement signal is pressed for a short time.

FIG. 15 shows a case where an upward movement signal is input. The direction of a movement signal is equal to a direction in which a user wants to move the data display window. Accordingly, the direction in which a data list moves is opposite to the direction of a movement signal.

Referring to FIG. 15, the left side of FIG. 15 shows a data list before movement, and the right side of FIG. 15 shows a data list after movement. A box represented by bold lines represents a part which is displayed on the data display window. The data list illustrated in FIG. 15 is equal to the data list of FIG. 13 in which data is arranged according to two categories “ARTIST” and “TITLE”.

On a data display window 910 before movement, data items are displayed from “RADIO #1” to “VENUS”. If an upward movement signal is input, data “RADIAN” which is not displayed on the data display window 910 has to be displayed. Accordingly, the list has to be moved downwardly in a unit of a data piece. After the list is moved, data that is to be displayed on a data display window is from “RADIAN” to “UNIVERSAL TRAVELLER” (900).

Referring to the right side of FIG. 15, a data list after movement is displayed. Data from “RADIAN” to “UNIVERSAL TRAVELLER” 930 is displayed on a data display window.

FIG. 16 shows a case where a fast movement signal is input. The fast movement signal is generated when a button or a slide bar for generating an upward movement signal or a downward movement signal is pressed for a long time.

FIG. 16 shows a case where a fast upward movement signal is input. As illustrated in FIG. 16, a list is moved downward in a unit of a page. In FIG. 16, a page includes 10 pieces of digital data. The number of pieces of data included in a page can vary according to settings of a portable data storage apparatus.

According to another embodiment, when a fast movement signal is input, data having the previous or preceding item value of the item value of a first search category corresponding to data displayed on a current display window can be displayed. For example, if a current first search category is “ARTIST”, an “ARTIST” item value of data displayed on a data display window is “BOA”, and a fast upward movement signal is input, data having an “ARTIST” item value “AIR” just before the “BOA” can be displayed.

In the example of FIG. 16, data is first sorted on the basis of the first category “ARTIST”, and data having the same item value of the first category “ARTIST” is secondarily sorted on the basis of a second category “TITLE”. On a data display window 1010 before movement, data is displayed from “TALISMAN” of “AIR” to “LADY GALAXY” of “BOA”. If a user inputs a fast upward movement signal, the data list is moved downwardly in a unit of a page. A data list part 1000 which was not displayed before movement is displayed on a data display window 1020 after movement. Data displayed on the data display window 1010 before movement is not displayed on the data display window after the data is moved downwardly (1030).

In the portable data storage apparatus according to the present invention, a case where “RUN” of “AIR” is selected while “CANDLE LIGHTS” of “BOA” is reproduced is described below.

First, since a user knows an artist and a title, he or she inputs an artist as a first search category and a title as a second search category. This operation can be performed by a single button manipulation as described above with reference to FIG. 9. Also, unlike the conventional method, the user needs not to stop reproduction of music which is currently being reproduced. Here, since the currently selected data is “CANDLE LIGHTS” of “BOA”, data 1010 as illustrated in the left side of FIG. 16 is displayed on a data display window. Then, if a fast upward movement button is pressed in order to search for music which corresponds to an artist “AIR”, data 1020 as illustrated in the right side of FIG. 16 will be displayed on the data display window. If “RUN” which is the user's desired music is displayed on the data display window, he or she selects “RUN”. In this case, in order to move data from “CANDLE LIGHTS” of “BOA” to “RUN” of “AIR”, only three button manipulations are needed

Meanwhile, as described above with reference to FIG. 17, in the case of the conventional method, at least five button manipulations are required.

As such, the data search method according to the present invention easily and quickly accesses desired data, compared to the conventional method. Also, since the data search method helps a user to directly perform a data access method, the data search method is matched to a person's thought and recognition structure. This characteristic provides convenience to users, and helps users to concentrate on searching for their desired data. In the conventional hierarchical search method, since a user has to always memorize a location which he or she currently searches for, he or she cannot concentrate on searching for his or her desired data. Furthermore, according to the present invention, it is possible to search for other data without stopping reproduction of data.

The present invention can also be embodied as computer readable codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and so on.

As described above, in a portable data storage apparatus and a method of allowing a user to select digital data using the portable data storage apparatus, according to the present invention, since a list of all data is sorted on the basis of item values of at least one search category so that a user can select one piece of data from the list of data, the user can easily and quickly search for his or her desired data. Also, since the present invention helps a user to directly perform a data access method, the present invention is matched to a person's thought and recognition structure. This characteristic provides convenience to users and helps users to concentrate on searching for their desired data. Furthermore, according to the present invention, it is possible to search for other data without stopping reproduction of data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of allowing a user to select one piece of digital data from among a plurality of pieces of digital data, in a data storage apparatus storing metadata regarding a plurality of categories for the plurality of pieces of digital data, the method comprising:
receiving a first category which is a search criterion, from among the plurality of categories;
sorting a list of the plurality of pieces of digital data on the basis of item values of the first category;
displaying the sorted list of the plurality of pieces of digital data; and
receiving a selected one piece of digital data selected by the user among the sorted list of the plurality of pieces of digital data.

2. The method of claim 1, wherein the sorting of the list of the plurality of pieces of digital data further comprises sorting digital data having the same item value of the first category, on the basis of item values of a second category, wherein the second category is different from the first category, from among the plurality of categories.

3. The method of claim 2, wherein the receiving of the first category comprises successively receiving the first category and the second category.

4. The method of claim 1, wherein the displaying of the sorted list of the plurality of pieces of the digital data comprises:
receiving an upward movement signal or a downward movement signal; and
moving the sorted list of digital data upwardly or downwardly, according to the upward movement signal or the downward movement signal, respectively, to generate a resultant list and displaying the resultant list.

5. The method of claim 4, wherein the moving of the sorted list and the displaying of the resultant list comprises:
if the upward movement signal or the downward movement signal is a normal movement signal, moving the sorted list upwardly or downwardly in units of digital data pieces, and displaying the resultant list; and
if the upward movement signal or the downward movement signal is a fast movement signal, moving the sorted list in units of pages, and displaying the resultant list.

6. The method of claim 1, wherein the digital data is sound source data, and the plurality of categories comprise an artist, an album, a genre, and a title.

7. The method of claim 1, further comprising displaying an item value for each of the plurality of categories, for the selected one piece of digital data.

8. The method of claim 1, further comprising reproducing the selected one piece of digital data.

9. The method of claim 1, further comprising, if the selected one piece of digital data is not stored in the data storage apparatus, requesting a different data storage apparatus to transmit the selected one piece of digital data, and receiving the selected one piece of digital data from the other data storage apparatus.

10. A data storage apparatus comprising:
a data storage unit which stores digital data;
a metadata storage unit which stores metadata regarding a plurality of categories for a plurality of pieces of digital data including the digital data stored in the data storage unit;
a search criterion input unit which receives at least one category which is a search criterion, from among the plurality of categories;
a list sorting unit which sorts a list of the plurality of pieces of digital data on the basis of item values of the at least one category;
a list display unit which displays the sorted list of the plurality of pieces of digital data;
a selection input unit which receives a selected one piece of digital data selected by a user, from among the sorted list of the plurality of pieces of digital data.

11. The apparatus of claim 10, wherein the search criterion input unit comprises a plurality of input buttons corresponding to the plurality of categories, and if at least one input button of the plurality of input buttons is pressed, a category corresponding to the at least one input button is input to the list sorting unit.

12. The apparatus of claim 11, wherein, if an input button of the plurality of input buttons is pressed, a category corresponding to the input button is input as a first category to the list sorting unit, and the list storing unit sorts the list of the plurality of pieces of digital data on the basis of item values of the first category.

13. The apparatus of claim 11, wherein,
if a first input button and a second input button of the plurality of input buttons are successively pressed, categories corresponding to the first input button and the second input button are input as a first category and a second category to the list sorting unit, respectively, and
the list sorting unit sorts the list of the plurality of pieces of digital data on the basis of item values of the first category, and then sorts a list of digital data having the same item value of the first category, on the basis of item values of the second category.

14. The apparatus of claim 10, wherein the selection input unit further comprises a movement signal input unit receiving an upward movement signal or a downward movement signal, and transferring the upward movement signal or the downward movement signal to the list display unit,
wherein, if the upward movement signal or the downward movement signal is transferred from the movement signal input unit, the list display unit moves the sorted list of the plurality of pieces of digital data upwardly or downwardly according to the upward movement signal or the downward movement signal, respectively, to generate a resultant list and displays the resultant list.

15. The apparatus of claim 14, wherein, if the upward movement signal or the downward movement signal is a normal movement signal, the list display unit moves the sorted list upwardly or downwardly in units of digital data pieces and displays the resultant list, and if the upward movement signal or the downward movement signal is a fast movement signal, the list display unit moves the sorted list in units of pages and displays the resultant list.

16. The apparatus of claim 15, wherein the movement signal input unit comprises an upward movement button and a downward movement button corresponding to the upward movement signal and the downward movement signal, respectively, and recognizes the normal movement signal as a movement signal having a direction corresponding to a pressed upward movement button or pressed downward movement button if the pressed movement button is pressed for a short time, and transfers the normal movement signal to the list display unit, and recognizes the fast movement signal as a movement signal having a direction corresponding to the pressed upward movement button or pressed downward movement button if the pressed movement button is pressed for a long time, and transfers the fast movement signal to the list display unit.

17. The apparatus of claim 10, wherein the digital data is sound source data, and the plurality of categories include an artist, an album, a genre, and a title.

18. The apparatus of claim 10, further comprising a selected data display unit which displays an item value for each of the plurality of categories, for the selected digital data.

19. The apparatus of claim 10, further comprising a data reproducing unit which reproduces the selected digital data.

20. The apparatus of claim 10, further comprising a data interface unit which requests a second data storage apparatus to transmit the selected digital data, if the selected digital data is not stored in the data storage unit, receives the selected digital data from the second data storage apparatus, and stores the selected digital data in the data storage unit.

21. A computer readable recording medium having encoded thereon a program for executing a method which allows a user to select one piece of digital data from among a plurality of pieces of digital data, in a data storage apparatus which stores metadata regarding a plurality of categories for each of the plurality of pieces of digital data, the method comprising:
receiving a first category which is a search criterion, from among the plurality of categories;
sorting a list of the plurality of pieces of digital data on the basis of item values of the first category;
displaying the sorted list of the plurality of pieces of digital data; and
receiving a selection of one piece of digital data by the user, from among the list of the plurality of pieces of digital data.
